(19) United States
(12) Patent Application Publication
(10) Pub. No.: US 2016/0214612 A1
(43) Pub. Date: Jul. 28, 2016

(54) AUTONOMOUS DRIVING DEVICE

(71) Applicant: TOYOTA JIDOSHA KABUSHIKI KAISHA, Toyota-shi (JP)

(72) Inventors: Yusuke KASHIBA, Tokyo (JP); Toshiyuki MATSUBARA, Gotenba-shi (JP)

(73) Assignee: TOYOTA JIDOSHA KABUSHIKI KAISHA, Toyota-shi (JP)

(21) Appl. No.: 14/951,751

(22) Filed: Nov. 25, 2015

(30) Foreign Application Priority Data
Jan. 22, 2015 (JP) 2015-010033

(51) Int. Cl. B60W 30/18; B60W 10/04; B60W 10/20; G05D 1/00; B60W 10/18

(52) U.S. Cl. CPC B60W 30/18163; G05D 1/0088; B60W 10/18; B60W 10/20; B60W 10/04; B60W 2550/30; B60W 2710/18; B60W 2710/20; B60W 2720/10

(57) ABSTRACT

In a case where it is determined that a merging travel control cannot be executed, a host vehicle is caused by a stop control unit to stop in a travelling lane toward a boundary line between the travelling lane and a merging destination lane. For this reason, the possibility increases that the range, over which the driver of the host vehicle can directly view the merging destination lane from the side window, will widen. Therefore, when the driver of the host vehicle restarts the host vehicle by the manual driving, it is possible to improve the easiness of checking the status in the merging destination lane.

### TECHNICAL FIELD

The present invention relates to an autonomous driving device.

### BACKGROUND

In the related art, as disclosed in Japanese Unexamined Patent Application Publication No. 11-39599, an autonomous merging system of an autonomous driving vehicle is known.

The autonomous merging system is configured to perform a merging travel control of a host vehicle that travels by an autonomous travelling toward a merging place between a travelling lane in which the host vehicle travels and a merging destination lane to which the travelling lane merges, in such a manner that the host vehicle merges into the merging destination lane by the autonomous driving.

### SUMMARY

In the related art described above, in a certain case, a host vehicle cannot merge into a merging destination lane by an autonomous driving due to another vehicle or the like travelling in the merging destination lane, and thus, the host vehicle stops in front of the boundary line between a travelling lane and the merging destination lane. In this case, a driver of the host vehicle restarts the host vehicle by a manual driving and causes the host vehicle to merge into the merging destination lane by the manual driving. However, when the driver of the host vehicle restarts the host vehicle by the manual driving, in some cases, it is difficult to check the status of the merging destination lane, and thus, an improvement is desired in this respect.

Therefore, an object of the present invention is to provide an autonomous driving device in which, in a case where the host vehicle cannot merge into the merging destination lane by the autonomous driving and the host vehicle stops, when the driver of the host vehicle restarts the host vehicle by the manual driving, the easiness for checking the status of the merging destination lane can be improved.

According to an aspect of the present invention, there is provided an autonomous driving device configured to perform a merging travel control of a host vehicle that travels by autonomous travelling toward a merging place between a travelling lane in which the host vehicle travels and a merging destination lane to which the travelling lane merges, in such a manner that the host vehicle merges into the merging destination lane by the autonomous driving, the device including an another vehicle information acquisition unit configured to acquire another vehicle information relating to another vehicle travelling in the merging destination lane toward the merging place, a host vehicle information acquisition unit configured to acquire host vehicle information relating to the host vehicle, a map database configured to store map information, a determination unit configured to determine whether or not the merging travel control can be executed based on the another vehicle information, the host vehicle information, and the map information, and a stop control unit configured to control the travelling of the host vehicle in such a manner that the host vehicle stops in the travelling lane toward the boundary line between the travelling lane and the merging destination lane at the merging place, in a case where it is determined by the determination unit that the merging travel control cannot be executed.

According to this configuration, in a case where it is determined by the determination unit that the merging travel control cannot be executed, the travelling of the host vehicle is controlled by the stop control unit such that the host vehicle stops in the travelling lane toward the boundary line between the travelling lane and the merging destination lane at the merging place. For this reason, the possibility increases that the range, over which the driver of the host vehicle can directly view the merging destination lane from the side window, will widen. Therefore, when the driver of the host vehicle restarts the host vehicle by the manual driving, it is possible to improve the easiness of checking the status in the merging destination lane.

The stop control unit may be configured to cause the host vehicle to stop in such a manner that an angle between a center axis extending in a longitudinal direction of the host vehicle and a direction of the merging destination lane at the merging place becomes the preset angle based on the host vehicle information and the map information.

According to this configuration, the host vehicle is caused to stop by the stop control unit based on the host vehicle information and the map information in such a manner that the angle between the center axis extending in the longitudinal direction of the host vehicle and the direction of the merging destination lane at the merging place becomes a preset angle. Therefore, the possibility increases more that the range, over which the driver of the host vehicle can directly view the merging destination lane from the side window, will widen.

In a case where it is determined by the determination unit that the merging travel control cannot be executed, the stop control unit may be configured to cause the host vehicle to stop in such a manner that the direction of the steered wheel of the host vehicle becomes parallel to the extending direction of the travelling lane at the merging place.

According to this configuration, the host vehicle is caused to stop in such a manner that the direction of the steered wheel of the host vehicle becomes parallel to the extending direction of the travelling lane at the merging place. For this reason, when the driver of the host vehicle restarts the host vehicle by the manual driving, it is easy for the driver of the host vehicle to cause the host vehicle to accelerate and travel in the direction parallel to the travelling lane. Therefore, it is possible to cause the host vehicle to easily merge into the merging destination lane.

According to the present invention, in a case where the host vehicle cannot merge into the merging destination lane by the autonomous driving and the host vehicle stops, when the driver of the host vehicle restarts the host vehicle by the manual driving, it is possible to improve the easiness for checking the status of the merging destination lane.

### BRIEF DESCRIPTION OF THE DRAWINGS

FIG. 1 is a block diagram illustrating a configuration of an autonomous driving device in a first embodiment.

FIG. 2 is a plan view illustrating a status at a merging place between a travelling lane in which a host vehicle travels and a merging destination lane to which the travelling lane merges.

FIG. 3 is a flowchart illustrating a main flow of an operation of the autonomous driving device in FIG. 1.

FIG. 4 is a flowchart illustrating processing of a merging determination by the autonomous driving device in FIG. 1.

FIG. 5 is a flowchart illustrating processing of a stop control by the autonomous driving device in FIG. 1.

FIG. 6 is a plan view illustrating a viewing area in a case where the host vehicle is caused to stop in such a manner that an angle between a center axis extending in a longitudinal direction of the host vehicle and a merging destination lane at the merging place becomes zero.

FIG. 7 is a plan view illustrating a viewing area in a case where the host vehicle is caused to stop in such a manner that an angle between a center axis extending in a longitudinal direction of the host vehicle and a merging destination lane at the merging place becomes a stop angle θ.

FIG. 8 is a graph illustrating a size of the viewing area to the stop angle θ.

FIG. 9 is a graph illustrating a lateral position y of the stop position to the stop angle θ.

FIG. 10 is a plan view illustrating a direction of steered wheel of the host vehicle and the extending direction of the travelling lane at the merging place.

FIG. 11 is a plan view illustrating a viewing area in a case where the host vehicle is caused to stop when the travelling lane in which the host vehicle travels merges into the merging destination lane from the right side of the travelling direction of the merging destination lane.

### DETAILED DESCRIPTION

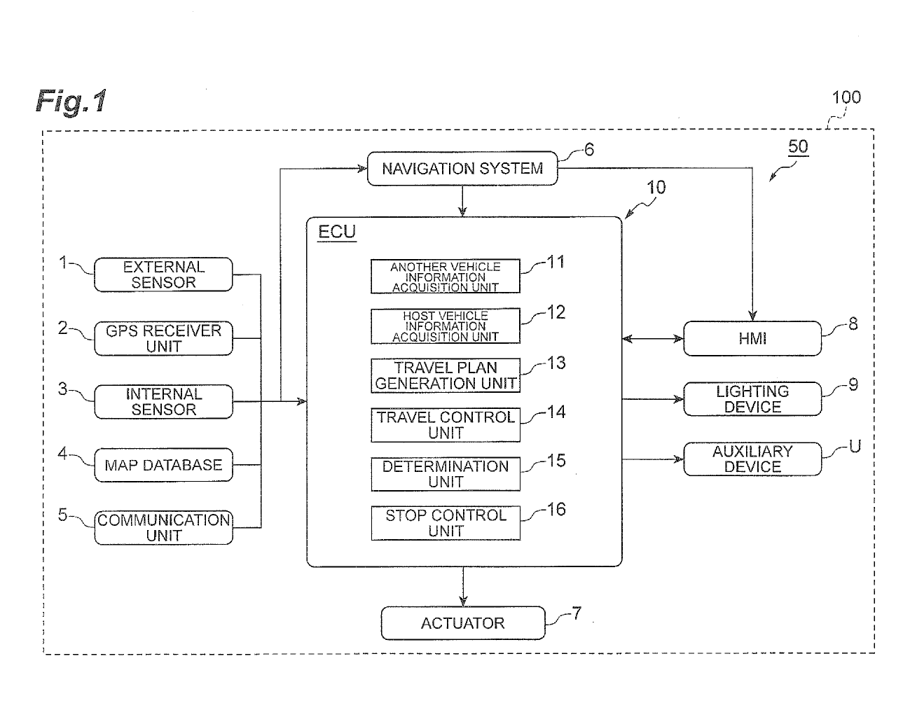

Hereinafter, an embodiment of the present invention will be described in details with reference to the drawings. As illustrated in FIG. 1, an autonomous driving device 50 is mounted on a host vehicle 100. The autonomous driving device 50 performs merging travel control of a host vehicle in such a manner that the host vehicle merges into a merging destination lane by an autonomous driving with respect to the host vehicle travelling by the autonomous driving toward a merging place between the travelling lane in which the host vehicle travels and a merging destination lane to which the travelling lane merges.

The autonomous driving means that a driving operation of the host vehicle such as an acceleration, a deceleration, and a steering is executed regardless of the driving operation of the driver of the host vehicle. The merging travel control means that the travelling of the host vehicle is controlled regardless of the driving operation of the driver of the host vehicle in such a manner that the host vehicle merges into a position between other vehicles travelling in the merging destination lane, based on information relating to the other vehicle travelling in the merging destination lane toward the merging place, information relating to the host vehicle, and map information.

As illustrated in FIG. 1, the autonomous driving device 50 includes an external sensor 1, a global positioning system (GPS) receiving unit 2, an internal sensor 3, a map database 4, a communication unit 5, a navigation system 6, an actuator 7, a human machine interface (HMI) 8, a lighting device 9 and an auxiliary device U, and an electronic control unit (ECU) 10.

The external sensor 1 is a detection device configured to detect an external situation which is peripheral information of the host vehicle 100. The external sensor 1 includes at least one of a camera, a radar, and a laser imaging detection and ranging (LIDAR). The camera is an imaging device configured to image the external situation of the host vehicle 100.

The camera is, for example, provided on the inside of windshield of the host vehicle 100. The camera transmits the image information on the external situation of the host vehicle 100 to the ECU 10. The camera may be monocular camera or may be a stereo camera. The stereo camera has two imaging units that are arranged so as to reproduce a binocular parallax. The image information of the stereo camera also includes information on the depth direction.

The radar detects an obstacle outside of the host vehicle 100 using a radio wave (for example, a millimeter wave). The radar detects the obstacle by transmitting the radio wave to the surroundings of the host vehicle 100 and receiving the wave reflected from the obstacle. The radar transmits detected obstacle information to the ECU 10.

The LIDAR detects the obstacle outside the host vehicle 100 using light. The LIDAR transmits the light to the surroundings of the host vehicle 100, measures the distance to the reflection point by receiving the light reflected from the obstacle, and then, detects the obstacle. The LIDAR transmits the detected obstacle information to the ECU 10. The camera, the LIDAR, and the radar are not necessarily provided in an overlapping manner.

The GPS receiver unit 2 measures the position of the host vehicle 100 (for example, the latitude and the longitude of the host vehicle 100) by receiving signals from three or more GPS satellites. The GPS receiver unit 2 transmits the measured position information of the host vehicle 100 to the ECU 10. Instead of the GPS receiver unit 2, another means for specifying the latitude and the longitude of the host vehicle 100 may be used.

The internal sensor 3 is a detection device configured to detect a travelling state of the host vehicle 100. The internal sensor 3 includes at least one of a vehicle speed sensor, an acceleration sensor, or a yaw rate sensor. The vehicle speed sensor is a detection device configured to detect the speed of the host vehicle 100. As the vehicle speed sensor, for example, a wheel speed sensor is used, which is provided on vehicle wheels of the host vehicle 100 or a drive shaft and the like rotating integrally with vehicle wheels and detects a rotation speed of the vehicle wheels. The vehicle speed sensor transmits the detected vehicle speed information (vehicle wheel speed information) to the ECU 10.

The acceleration sensor is a detection device configured to detect an acceleration of the host vehicle 100. The acceleration sensor includes, for example, a longitudinal acceleration sensor that detects acceleration in the longitudinal direction of the host vehicle 100 and a lateral acceleration sensor that detects a lateral acceleration of the host vehicle 100. The acceleration sensor transmits, for example, acceleration information of the host vehicle 100 to the ECU 10. The yaw rate sensor is a detection device of the host vehicle 100 configured to detect a yaw around the vertical axis of the center of the gravity of the host vehicle 100 (rotation angular velocity). As the yaw rate sensor, for example, a Gyro sensor can be used. The yaw rate sensor transmits detected yaw rate information of the host vehicle 100 to the ECU 10.

In addition, the internal sensor 3 includes a sensor that detects a driving operation by the driver to an accelerator pedal, a brake pedal or a steering wheel. As the sensor that detects the driving operation to the accelerator pedal and the brake pedal, for example, a sensor can be used, which is provided on the accelerator pedal or the brake pedal and detects a depression amount of the accelerator pedal or the brake pedal (position of the accelerator pedal or the brake pedal). In addition, the sensor that detects the driving operation to the accelerator pedal or the brake pedal may be a sensor that detects the depression amount of the accelerator pedal or the brake pedal from a driving force to the accelerator pedal or the brake pedal (a depression force to the accelerator pedal or the brake pedal or a pressure to a master cylinder, or the like).

As the sensor that detects the driving operation to the steered wheel, a torque sensor can be used, which is mounted on a rotation axis of the steered wheel and detects a steering torque to the steered wheel. In addition, as the sensor that detects the driving operation to the steered wheel, a touch sensor can be used, which is installed on the surface of the steered wheel.

The map database 4 is a database in which map information is included. The map database 4 is formed, for example, in a hard disk drive (HDD) mounted on the vehicle. In the map information, for example, position information of the road, information of the road type (for example, type of a curve or a straight portion or a curvature of the curve), and position information of the intersection, the branch point, and the merging place are included. It is preferable that the map information includes an output signal of the external sensor 1 in order to use the position information of a shielding structure such as a building or a wall and the simultaneous localization and mapping technology (SLAM). The map database may be stored in a computer in the facility such as an information processing center which is capable of communicating with host vehicle 100.

The communication unit 5 is a road-to-vehicle communication device that communicates with roadside facilities including the sensors installed on the road, for example, a camera for imaging the surroundings of the merging place and a radar sensor for detecting an object around the merging place and a LIDAR, and can acquire the detection information on those sensors and the like. In addition, the communication unit 5 may be configured to be combined with a vehicle-to-vehicle communication device capable of a vehicle-to-vehicle communication with the other vehicle.

The navigation system 6 is a device configured to perform guidance to a destination set by a driver of the host vehicle 100 on a driver of the host vehicle 100. The navigation system 6 calculates a travelling route of the host vehicle 100 based on the position information of the host vehicle 100 measured by the GPS receiver unit 2 and the map information in the map database 4. The route may be a specific lane suitable for driving in a multi-lane section. The navigation system 6 calculates, for example, a target route from the position of the host vehicle 100 to the destination and performs the notification to the driver by a displaying on a display of the HMI 8 or a voice output of a speaker of the HMI 8. The navigation system 6, for example, transmits the target route information of the host vehicle 100 to the ECU 10. The navigation system 6 may be stored in a computer in the facility such as an information processing center which is capable of communicating with host vehicle 100.

The actuator 7 is a device configured to perform a travel control of the host vehicle 100. The actuator 7 includes at least a throttle actuator, a brake actuator, and a steering actuator. The throttle actuator controls a supply amount (throttle opening degree) of air to an engine according to the control signal from the ECU 10, and controls the driving force of the host vehicle 100. In a case where the host vehicle 100 is a hybrid vehicle or an electric vehicle, the actuator 7 does not include the throttle actuator and the driving force is controlled by the control signal input to a motor as a source of the driving force from the ECU 10.

The brake actuator controls a brake system according to the control signal from the ECU 10 and controls the braking force given to the wheels of the host vehicle 100. For example, a hydraulic brake system can be used as the brake actuator. The steering actuator controls the driving of an assist motor that controls steering torque in the electric power steering system according to the control signal from the ECU 10. In this way, the steering actuator controls the steering torque of the host vehicle 100.

The HMI 8 is an interface configured to perform an input and output of the information between the occupants (including the driver) of the host vehicle 100 and the autonomous driving device 50. The HMI 8 includes, for example, a display panel for displaying the image information for the occupant, a speaker for the voice output, and an operation button or a touch panel for the occupant to perform the input operation. When control to operate or to stop the autonomous drivinging is performed by the ECU 10, the HMI 8 starts or stops the autonomous travelling by outputting a signal to the occupant. In addition, when an operation to operate or to stop the autonomous driving is input by the occupant, the HMI 8 starts or stops the autonomous driving by outputting a signal to the ECU 10.

The lighting device 9 includes headlights, side turn signal lights, and hazard lights. During the execution of the autonomous driving, the side turn signal lights and hazard lights of the lighting device 9 are controlled by a control signal from the ECU 10. The auxiliary device U is a device that can usually be operated by the driver of the host vehicle 100 even during the execution of the autonomous driving.

The auxiliary device U is a device collectively referring to devices not included in the actuator 7 and the lighting device 9. The auxiliary device U in the present embodiment includes, for example, an air conditioning system and a wiper. The auxiliary device U may be automatically controlled by a control signal from the ECU 10 according to a temperature or the weather or the like around the host vehicle 100.

The ECU 10 controls the autonomous driving of the host vehicle 100. The ECU 10 is an electronic control unit including a central processing unit (CPU), read only memory (ROM), random access memory (RAM), and the like. The ECU 10 includes another vehicle information acquisition unit 11, a host vehicle information acquisition unit 12, a travel plan generation unit 13, a travel control unit 14, a determination unit 15, and a stop control unit 16. In the ECU 10, the control of each unit such as the another vehicle information acquisition unit 11 is performed by loading the program stored in the ROM into the RAM and executing the program by the CPU. The ECU 10 may be configured with a plurality of electronic control units.

The another vehicle information acquisition unit 11 acquires another vehicle information relating to the other vehicle travelling in the merging destination lane toward the merging place based on the information acquired from the external sensor 1 and the communication unit 5. In the another vehicle information, the position, speed, acceleration, direction, vehicle-to-vehicle distance, vehicle-to-vehicle time, and the full-length of each another vehicle travelling on the merging destination lane are included.

The host vehicle information acquisition unit 12 acquires host vehicle information relating to the host vehicle 100 based on the information acquired from the GPS receiver unit 2, the internal sensor 3, and the map database 4. In the host vehicle information, the position, speed, acceleration, direction, and the yaw rate of the host vehicle 100 are included.

The travel plan generation unit 13 generates a travel plan of the host vehicle 100 based on a target route calculated by the navigation system 6, the another vehicle information acquired by the another vehicle information acquisition unit 11, the host vehicle information acquired by the host vehicle information acquisition unit 12, and the map information acquired from the map database 4. The travel plan is a trajectory in which the host vehicle 100 travels on the target route.

The travel plan generation unit 13 generates the travel plan for executing the merging travel control based on the another vehicle information, the host vehicle information, and the map information.

When generating the travel plan for executing the merging travel control, the travel plan generation unit 13, for example, detects a plurality of spaces between each of the other vehicles on the merging destination lane as merging candidate spaces. Next, the travel plan generation unit 13 calculates a time difference between an arrival time of the host vehicle 100 at the merging place and an arrival time at the merging place in the merging candidate space. Furthermore, in a case where the merging candidate space of which the time difference is shorter than a predetermined time is detected, the travel plan generation unit 13 generates a travel plan for the host vehicle 100 to enter the merging candidate space. In the travel plan for the host vehicle 100 to enter the merging candidate space, for example, the speed, the acceleration, the deceleration, the direction, and the steering angle of the host vehicle 100 at each time are included.

The travel control unit 14 automatically controls the travel of the host vehicle 100 based on the travel plan generated in the travel plan generation unit 13. In a case where the travel plan for executing the merging travel control is generated by the travel plan generation unit 13, the travel control unit 14 executes the merging travel control based on the travel plan. The travel control unit 14 outputs a control signal according to the travel plan to the actuator 7. In this way, the travel control unit 14 controls the travelling of the host vehicle 100 in such a manner that the autonomous driving of the host vehicle 100 is executed according to the travel plan. In addition, the travel control unit 14 controls the switching mode from the autonomous driving to the manual driving based on the determination result of the determination unit 15.

The determination unit 15 executes a merging determination for determining whether or not the merging travel control can be executed based on the another vehicle information, the host vehicle information, and the map information. As described below, the merging determination is executed based on the references of: for example, whether or not the information on the merging destination lane can be acquired from the roadside facilities, whether or not the speed of the host vehicle 100 can reach the merge-able speed, whether or not the status in the merging destination lane can be recognized by the external sensor 1, and whether or not a sudden change has occurred in the merging destination lane. In addition, in the merging determination, in a case where it is determined that the merging travel control cannot be performed, the determination unit 15 determines whether or not there is a time for switching the driving mode from the autonomous driving to the manual driving.

In a case where it is determined by the determination unit 15 that the merging travel control cannot be performed and it is determined that there is no time for switching the driving mode from the autonomous driving to the manual driving, the stop control unit 16 executes the stop control to control the travelling of the host vehicle 100 in such a manner that the host vehicle 100 stops in the travelling lane toward the boundary line between the travelling lane and the merging destination lane at the merging place. The fact that the host vehicle 100 stops in the travelling lane toward the boundary line between the travelling lane and the merging destination lane at the merging place means that, for example, the host vehicle 100 stops in such a manner that the center axis extending in the longitudinal direction of the host vehicle 100 and the boundary line between the travelling lane and the merging destination lane at the merging place intersect each other. At the time of stop control, the stop control unit 16 cancels the travel plan generated by the travel plan generation unit 13 in the merging travel control and controls the travelling of the host vehicle 100 so as to travel on the travelling route newly determined by the stop control unit 16. The stop control unit 16 switches the driving mode from the autonomous driving to the manual driving after the host vehicle 100 stops by the stop control.

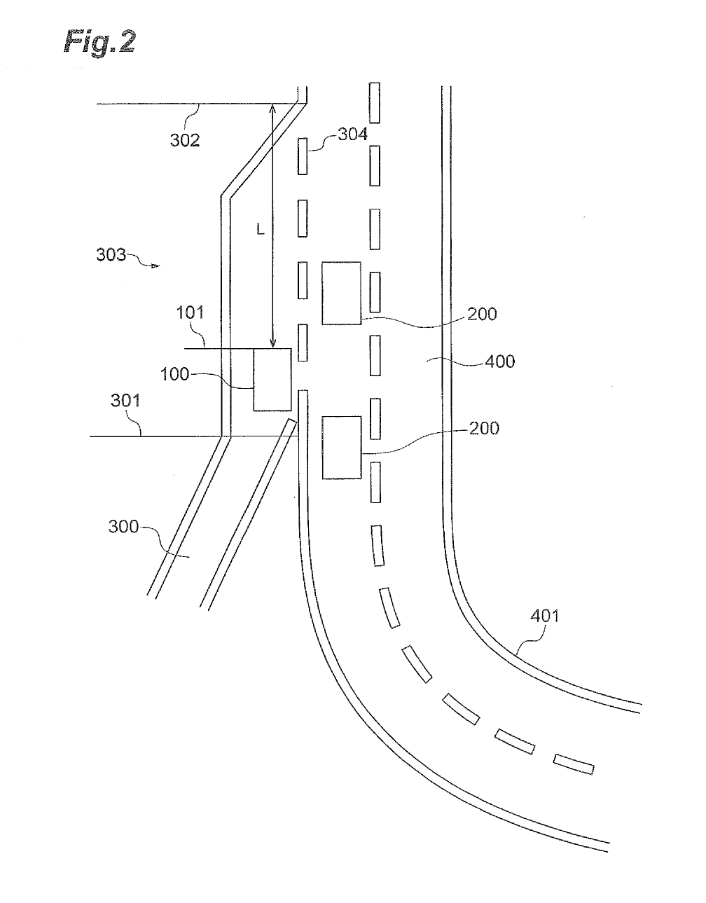

Next, the processing executed by the autonomous driving device 50 will be described. In the description described hereafter, it is assumed that the situation is as illustrated in FIG. 2. As illustrated in

FIG. 2, a travelling lane 300 on which the host vehicle 100 travels and a merging destination lane 400 on which a plurality of other vehicles 200 travels merge at a merging place 303. The travelling lane 300 is, for example, an ordinary road and the merging destination lane 400 is, for example, a highway.

The merging place 303 is a section from a merging place entrance 301 to a merging place termination 302, in which generally an acceleration lane is formed. In the merging place 303, the travelling lane 300 and the merging destination lane 400 are partitioned by a boundary line 304. In the example, in FIG. 2, the host vehicle 100 arrives at the position in which the distance from the merging place termination 302 to the front end 101 of the host vehicle 100 is the distance L. The merging destination lane 400 has a curve curved 401 to the opposite side of the merging place 303 in front of the merging place 303. In the vicinity of the merging place 303 in the merging destination lane 400, there is a (not illustrated) roadside facility having a sensor for acquiring information relating to the speed or the like of the other vehicles 200 travelling in the merging destination lane and is capable of road-to-vehicle communication with the host vehicle 100.

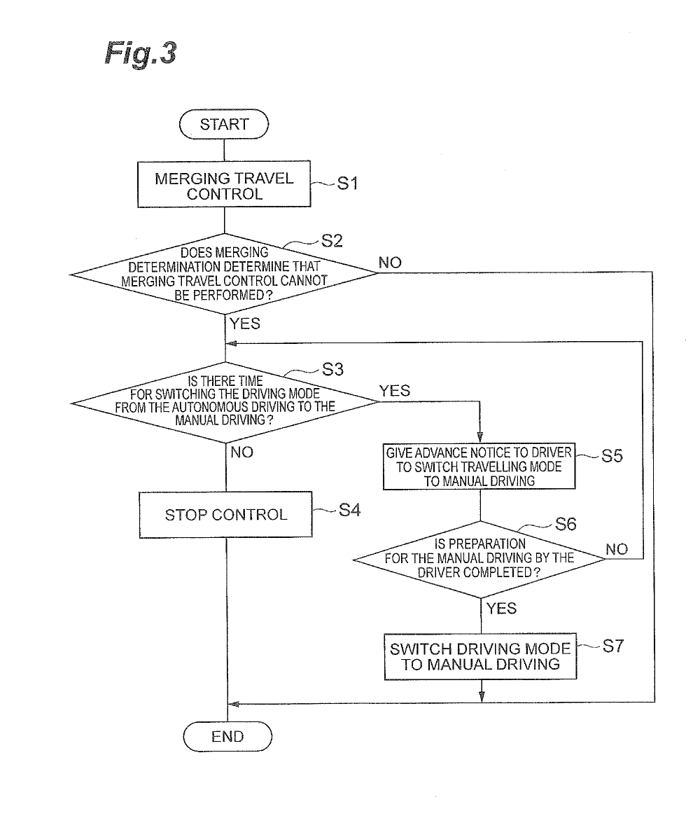

First, the main flow of the operation of the autonomous driving device 50 will be described. As illustrated in FIG. 3, the travel control unit 14 of the ECU 10 executes the merging travel control based on the travel plan generated by the travel plan generation unit 13 (S1). In a case where it is determined that the merging travel control cannot be performed according to the merging determination by the determination unit 15 (S2) and it is determined by the determination unit 15 that there is no time for switching the driving mode from the autonomous driving to the manual driving (S3), the stop control is executed by the stop control unit 16 (S4).

In a case where, for example, a margin time which is obtained by dividing the distance L from the merging place termination 302 to the front end 101 of the host vehicle 100 by the speed of the host vehicle 100 is equal to or greater than the preset threshold value, the determination unit 15 determines that there is a time for switching the driving mode from the autonomous driving to the manual driving, and in a case where the margin time is less than the threshold value, determines that there is no time for switching the driving mode from the autonomous driving to the manual driving. In a case where the host vehicle 100 is positioned in front of the merging place 303, the margin time may be a value obtained by dividing the distance from the merging place entrance 301 to the host vehicle 100 by the speed of the host vehicle 100.

In a case where it is determined by the determination unit 15 (S3) that there is a time for switching the driving mode from the autonomous driving to the manual driving, the travel control unit 14 gives prior notice to the driver through the HMI 8 to switch the driving mode to the manual driving (S5). In a case where a driving operation by the driver is detected by the internal sensor 3 and it is determined that the preparation for the manual driving by the driver is completed (S6), the travel control unit 14 switches the driving mode from the autonomous driving to the manual driving (S7). In a case where it is determined that the preparation for the manual driving by the driver is not completed (S6), the travel control unit 14 repeats the processing tasks in S5 to S6 until there is no time for switching the driving mode from the autonomous driving to the manual driving (S3).

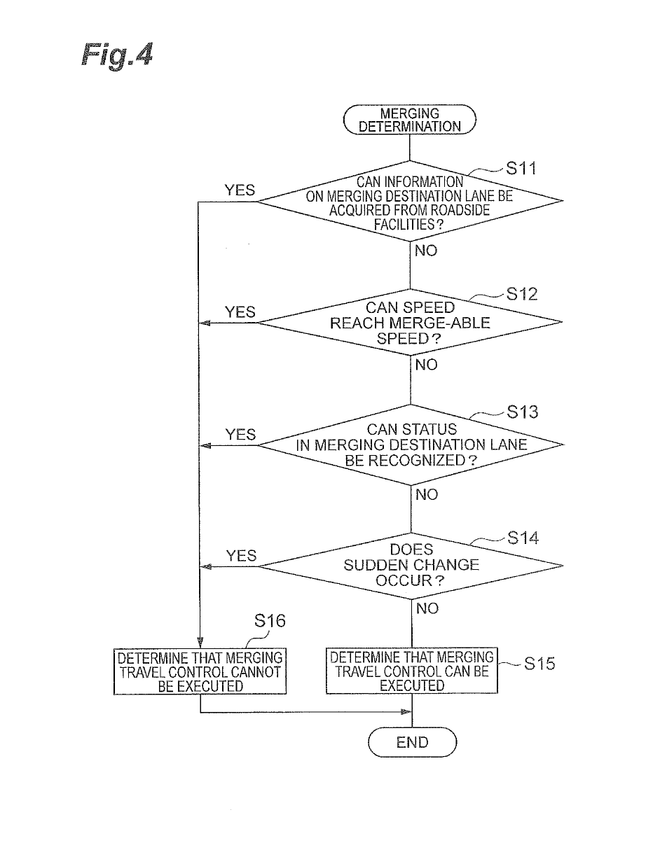

Hereinafter, processing of merging determination by the determination unit 15 will be described. As illustrated in FIG. 4, the determination unit 15 determines whether or not the information such as the speed of the other vehicle 200 in the merging destination lane 400 (a speed of a traffic flow in the merging destination lane 400) can be acquired from the roadside facilities of the merging destination lane 400 through the communication unit 5 (S11). In a case where the information on the merging destination lane 400 cannot be acquired from the roadside facilities due to a failure of the roadside facilities or the like, the determination unit 15 determines that the merging travel control cannot be executed (S16). In a case where the information on the merging destination lane 400 cannot be acquired from the roadside facilities, the determination unit 15 executes the processing in S12.

The determination unit 15 determines whether or not the speed of the host vehicle 100 reaches the merge-able speed based on the speed of the other vehicle 200 acquired from the roadside facilities via the communication unit 5, the speed of the host vehicle 100 detected by the internal sensor 3, the distance L from the merging place termination 302 to the front end 101 of the host vehicle 100, and the acceleration performance of the host vehicle 100 (S12). In a case where the speed of the host vehicle 100 cannot reach the merge-able speed due to the lack of distance L or the lack of the acceleration performance of the host vehicle 100, the determination unit 15 determines that the merging travel control cannot be executed (S16). In a case where the speed of the host vehicle 100 can reach the merge-able speed, the determination unit 15 executes the processing in S13.

The determination unit 15 determines whether or not the status in the merging destination lane 400 can be recognized using the external sensor 1 (S13). In a case where the status in the merging destination lane 400 cannot be recognized due to bad weather such as fog, the determination unit 15 determines that the merging travel control cannot be executed (S16). In this case, even when the status in the merging destination lane 400 can be recognized by the external sensor 1, also in a case where the vehicle-to-vehicle distance between the other vehicles 200 is much shorter than a predetermined threshold value, the determination unit 15 determines that the merging travel control cannot be executed. In a case where the status in the merging destination lane 400 can be recognized, the determination unit 15 executes the processing in S14.

The determination unit 15 determines whether or not a sudden change occurs in the travelling lane 300 or in the merging destination lane 400 using the external sensor 1 (S14). In a case where a preceding vehicle of the host vehicle 100 suddenly stops in the travelling lane 300 or in a case where an accident occurs in the travelling lane 300 or in the merging destination lane 400, the determination unit 15 determines that the sudden change occurs and that the merging travel control cannot be executed (S 16). In a case where an accident does not occur, the determination unit 15 determines that the merging travel control can be executed (S15).

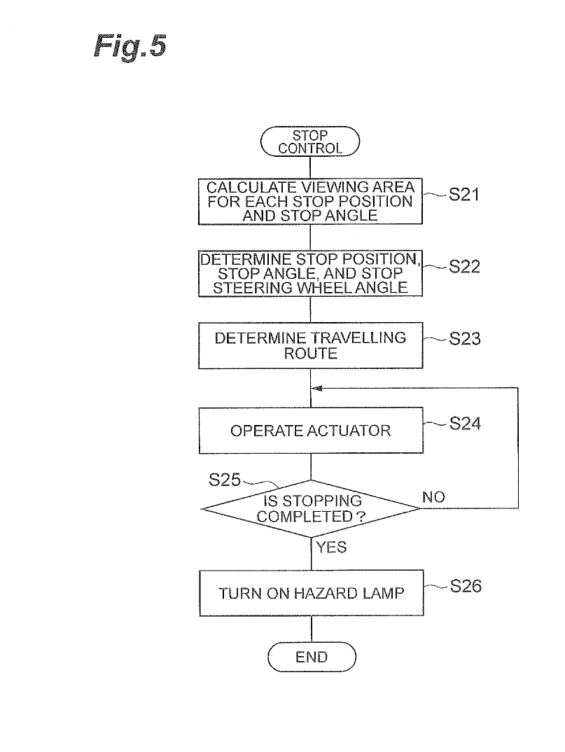

Hereinafter, the stop control by the stop control unit 16 will be described. As illustrated in FIG. 5, the stop control unit 16 calculates the viewing area for each stop position and the stop angle of the host vehicle 100 based on the host vehicle information acquired by the host vehicle information acquisition unit 12 and the map information in the map database 4 (S21).

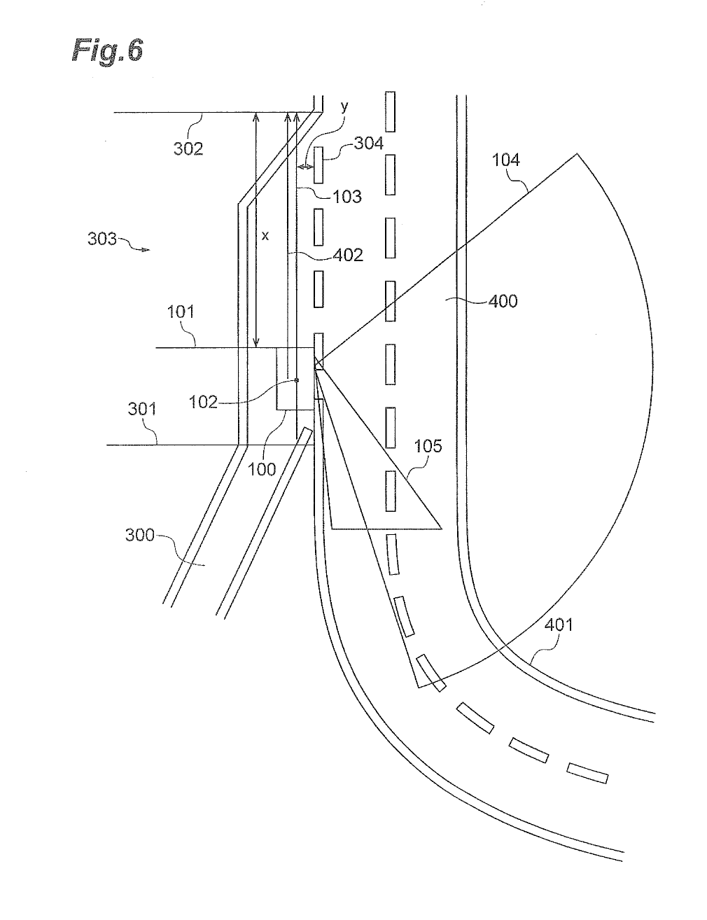

First, as illustrated in FIG. 6, a case is assumed, where the host vehicle 100 is caused to stop in such a manner that an angle between a center axis 103 extending in a longitudinal direction of the host vehicle 100 and a direction 402 of the merging destination lane 400 at the merging place 303 becomes zero. The center axis 103 passes through a center 102 of the host vehicle 100 and extends in the longitudinal direction of the host vehicle 100. Since the center axis 103 is parallel to the direction 402, the stop angle θ between the center axis and the direction 402 is zero. The stop position (x, y) of the host vehicle 100 is defined by the longitudinal position x which is the distance from merging place termination 302 to the front end 101 of the host vehicle 100 and the lateral position y which is the distance from the boundary line 304 to the center 102 of the host vehicle 100. In order to make the viewing area be wide, the host vehicle 100 approaches as close as possible to the boundary line 304 and stops.

An area that is assumed to be directly viewed by the driver of the host vehicle 100 via a side window of the host vehicle 100 is defined as a direct viewing area 104. In addition, an area that is assumed to be indirectly viewed by the driver of the host vehicle 100 via a side view mirror of the host vehicle 100 is defined as a mirror viewing area 105.

The direct viewing area 104 and the mirror viewing area 105 depend on the model of the host vehicle 100 and the physical conditions such as a visual acuity or the field of view range of the driver. Therefore, in the present embodiment, the direct viewing area 104 and the mirror viewing area 105 are set in a predetermined area based on the specification such as a size of the host vehicle 100 and the physical conditions of the ordinary driver that can be statistically obtained. In the present embodiment, an area in which each of the direct viewing area 104 and the mirror viewing area 105 and the merging destination lane 400 are overlapped is defined as the viewing area.

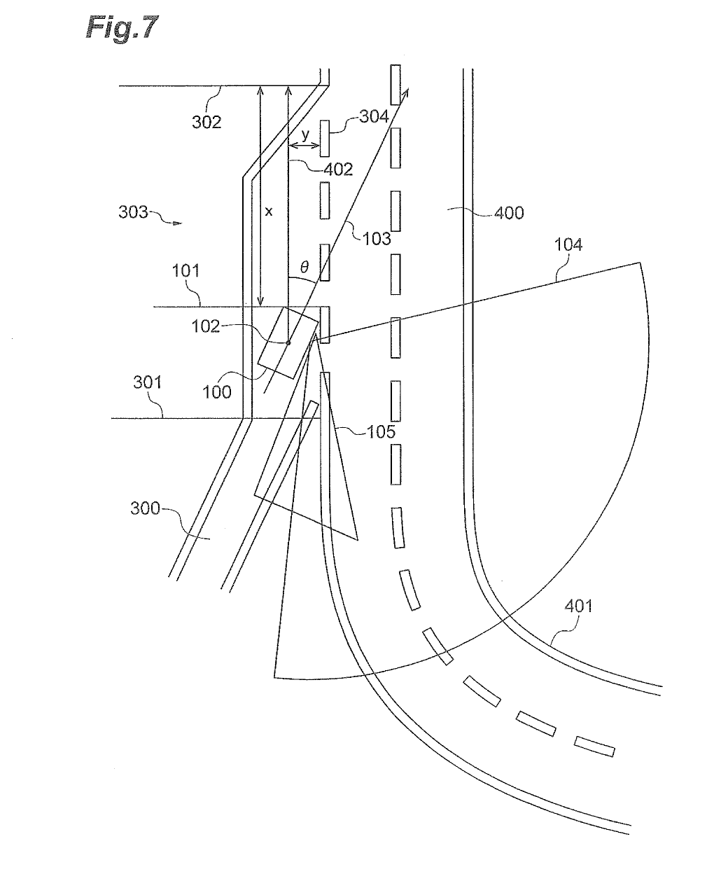

On the other hand, as illustrated in FIG. 7, a case is assumed, where the host vehicle 100 approaches as close as possible to the boundary line 304 and the host vehicle 100 is caused to stop in such a manner that an angle between a center axis 103 extending in a longitudinal direction of the host vehicle 100 and a direction 402 of the merging destination lane 400 at the merging place 303 becomes the stop angle θ. In the example in FIG. 7, since the merging destination lane 400 is curved to the opposite side of the merging place 303 by a curve 401, the stop angle θ becomes greater than 0°. Therefore, the overlapping area of the direct viewing area 104 and the merging destination lane 400 becomes large. The stop control unit 16 can calculate the viewing areas in each of the cases illustrated in FIG. 6 and FIG. 7 based on the position of the host vehicle 100 in the host vehicle information and the map information in the map database 4.

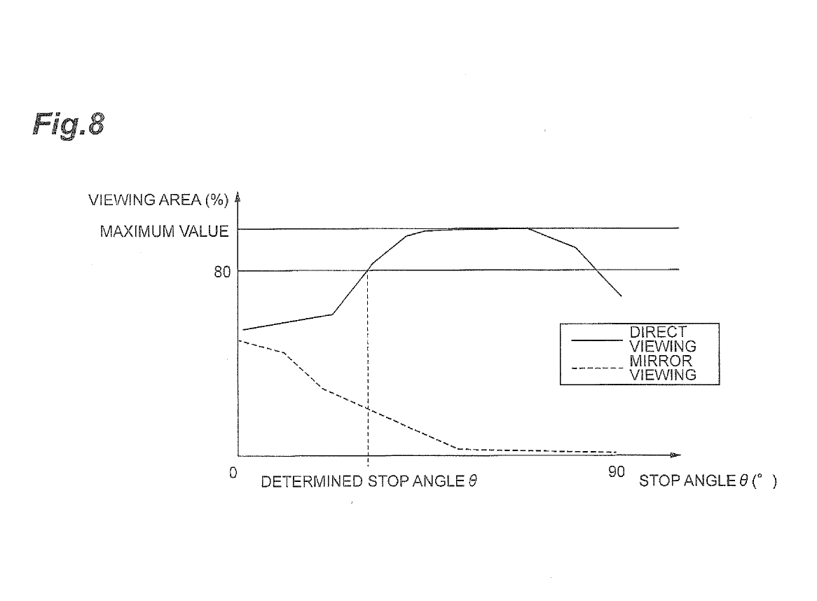

In FIG. 8, the size of the viewing area to the stop angle θ is illustrated. In a range of 0°<stop angle θ<90°, the maximum value of the viewing area in FIG. 8 means the maximum value of the area of the greater area among the overlapping area of the direct viewing area 104 and the merging destination lane 400 and the overlapping area of the mirror viewing area 105 and the merging destination lane 400. The solid line in FIG. 8 illustrates the ratio of the viewing area which is the overlapping area of the direct viewing area 104 and the merging destination lane 400 to the maximum value. The dashed line in FIG. 8 illustrates the ratio of the viewing area which is the overlapping area of the mirror viewing area 105 and the merging destination lane 400 to the maximum value.

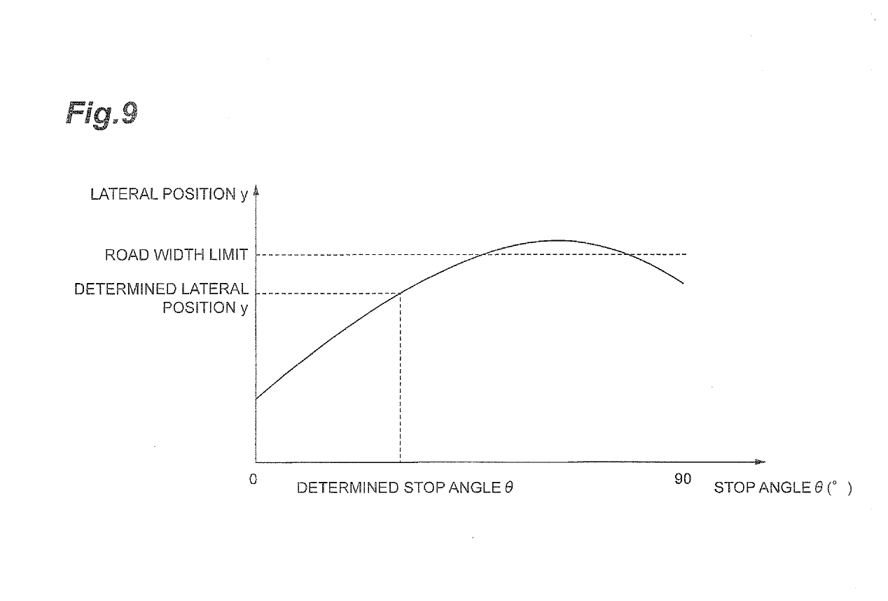

As illustrated in FIG. 8, the size of the viewing area in which the direct viewing area 104 and the merging destination lane 400 are overlapped becomes maximum at a certain stop angle θ. In addition, in a case where host vehicle 100 approaches as close as possible to the boundary line 304, as illustrated in FIG. 9, the lateral position y is a function in which the variable is the stop angle θ. The stop control unit 16 calculates the viewing area with respect to the longitudinal position x and the stop angle θ and calculates the lateral position y with respect to the stop angle θ. The viewing area with respect to the longitudinal position x, the lateral position y, and the stop angle θ may be calculated in advance before arriving at the merging place 303 and may be stored in associated with the map information in the map database 4.

Returning to FIG. 5, the stop control unit 16 determines the stop position (x, y), the stop angle θ, and a stopped steered wheel angle (S22). The stop control unit 16 can determine the longitudinal position x of the stop position (x, y) as an arbitrary position where the host vehicle 100 can stop before arriving at the merging place termination 302 based on, for example, the speed or the braking force of the host vehicle 100. Next, at the determined longitudinal position x, the stop control unit 16 determines the stop angle θ at which the ratio of the viewing area to the maximum value becomes a predetermined ratio. In the example in FIG. 8, the stop angle θ at which the ratio of the viewing area to the maximum value becomes 80% is determined.

If the stop angle θ becomes too large, when the host vehicle 100 restarts, the steering for making the center axis 103 of the host vehicle 100 parallel to the direction of the travelling lane 300 becomes difficult. In addition, as illustrated in FIG. 9, as the stop angle θ increases, the lateral position y also increases. However, since the lateral position y is limited by the road width of the travelling lane 300, the stop angle θ is also limited. However, the stop angle θ at which the size of the viewing area becomes maximum value may be determined. As illustrated in FIG. 9, the lateral position y with respect to the determined stop angle θ is determined.

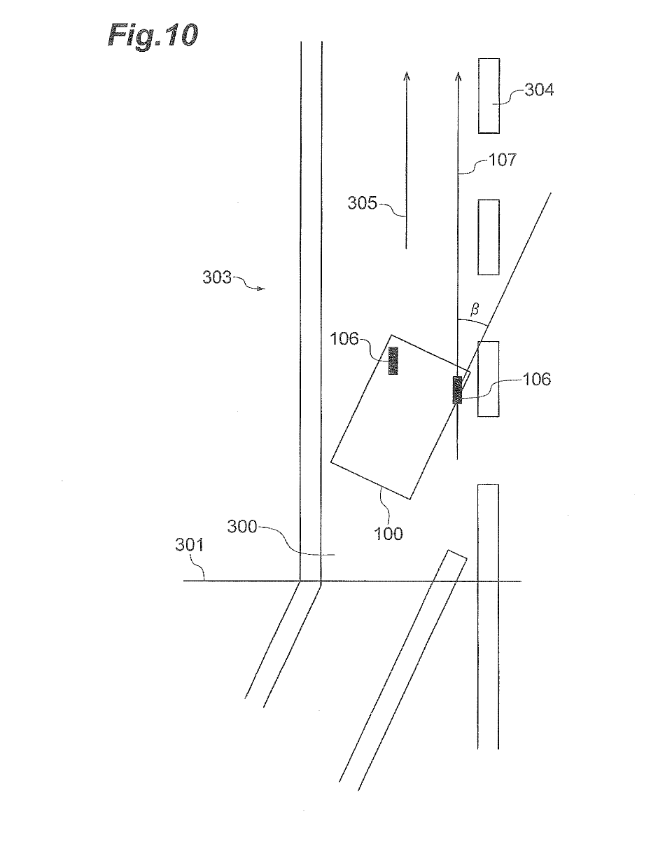

In addition, as illustrated in FIG. 10, in the present embodiment, in principle, a stop steered wheel angle β is determined in such a manner that the direction 107 of the steered wheel 106 becomes parallel to the extending direction 305 of the travelling lane 300 at the merging place 303. The stop steered wheel angle β is an angle between the direction 107 of the steered wheel 106 at the time of stopping and the direction of the steered wheel 106 at the time of neutral state. Since the direction 107 and the extending direction 305 are parallel to each other, when the host vehicle 100 restarts, if the driver maintains the steering angle until the center axis 103 of the host vehicle 100 becomes parallel to the extending direction 305, and when the center axis 103 and the extending direction 305 becomes parallel to each other, and then, if the stop steered wheel angle β becomes 0°, the driving operation at the time of restarting is easy.

The stop steered wheel angle β is determined within a range in which a rapid steering is not necessary at the time of restarting of the host vehicle 100. The rapid steering means, for example, a steering range in which a steering of equal to or greater than 90° per 0.5 second is necessary. In addition, the stop steered wheel angle 13 is determined within a range in which a rapid lateral acceleration does not occur at the time of restarting of the host vehicle 100. The rapid lateral acceleration means, for example, a lateral acceleration of equal to or greater than 0.3 G. In a case where the rapid steering is necessary or the rapid lateral acceleration occurs at the time of restarting of the host vehicle 100, the stop steered wheel angle 13 may not necessarily be determined in such a manner that the direction 107 and the extending direction 305 become parallel to each other.

In addition, in a case where the longitudinal position x at the stop position (x, y) is short and the host vehicle 100 stops at the position close to the merging place termination 302, the travelling distance of the host vehicle 100 travelling on the travelling lane 300 at the time of restarting becomes short. Therefore, the stop steered wheel angle β may not necessarily be determined in such a manner that the direction 107 and the extending direction 305 become parallel to each other. When the longitudinal position x is short, the stop steered wheel angle β may be 0°.

The stop control unit 16 determines the travelling route based on the determined stop position (x, y), the stop angle 0, and the stop steered wheel angle β (S23). The stop control unit 16 operates the actuator 7 in such a manner that the host vehicle 100 travels on the determined travelling route (S24). When the stopping of the host vehicle 100 is completed at the determined stop position (x, y), the stop angle θ, and the stop steered wheel angle β (S25), the stop control unit 16 turns on the hazard lights of the lighting device 9 (S26).

The stop control unit 16 switches the driving mode from the autonomous driving to the manual driving after the stop control is completed. At the time restarting, after checking the status in the merging destination lane 400 within the viewing area, the host vehicle 100 is caused to restart by the manual driving and the host vehicle 100 is caused to merge into the merging destination lane 400.

In the present embodiment, in a case where it is determined that the merging travel control cannot be executed, the travelling of the host vehicle 100 is controlled by the stop control unit 16 in such a manner that the host vehicle 100 stops on the travelling lane 300 toward the boundary line 304 between the travelling lane 300 at the merging place 303 and the merging destination lane 400. For this reason, the possibility increases that the range, over which the driver of the host vehicle 100 can directly view the merging destination lane 400 from the side window, will widen. Therefore, when the driver of the host vehicle 100 restarts the host vehicle 100 by the manual driving, it is possible to improve the easiness of checking the status in the merging destination lane 400.

In addition, the host vehicle 100 is caused to stop by the stop control unit 16 based on the host vehicle information and the map information in such a manner that the angle between the center axis 103 extending in the longitudinal direction of the host vehicle 100 and the direction 402 of the merging destination lane 400 at the merging place 303 becomes a preset angle. For this reason, the possibility increases more that the range, over which the driver of the host vehicle 100 can directly view the merging destination lane 400 from the side window, will widen.

In addition, in the present embodiment, the host vehicle 100 is caused to stop in such a manner that the direction of the steered wheel 106 of the host vehicle 100 becomes parallel to the extending direction 305 of the travelling lane 300 at the merging place 303. For this reason, when the driver of the host vehicle 100 restarts the host vehicle 100 by the manual driving, it is easy for the driver of the host vehicle 100 to cause the host vehicle 100 to accelerate and travel in the direction parallel to the travelling lane 300. Therefore, it is possible to cause the host vehicle 100 to merge into the merging destination lane 400.

As above, the embodiment of the present invention is described.

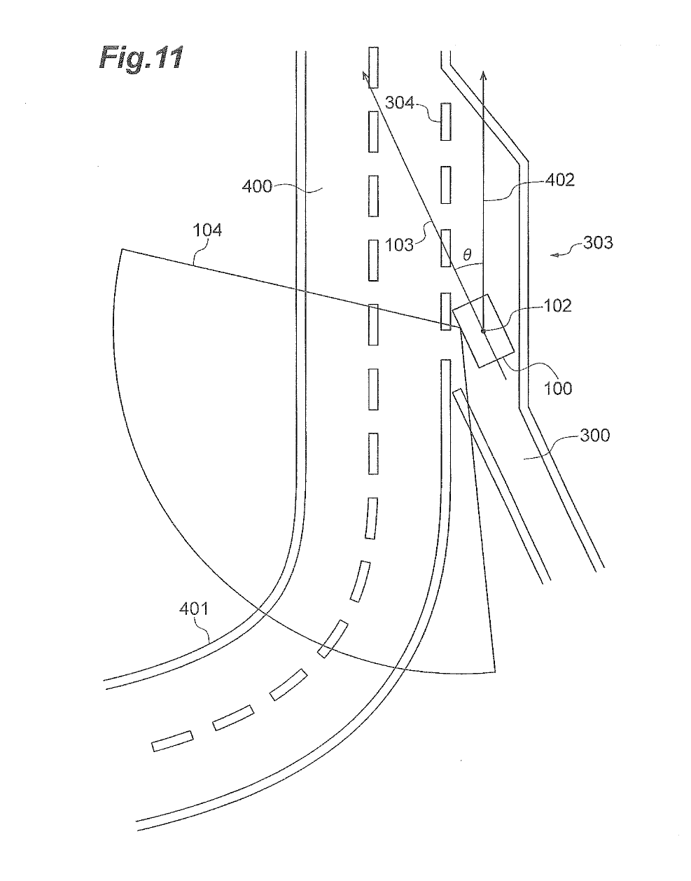

However, the present invention is not limited to the above-described embodiment, but may be embodied in various aspects. For example, as illustrated in FIG. 11, in a case where the travelling lane 300 in which the host vehicle 100 travels merges into the merging destination lane 400 from the right side of travelling direction of the merging destination lane 400, since the distance between the driver and the left side mirror become long, it is predicted that checking the status in the merging destination lane 400 through the side mirror is difficult. For this reason, as illustrated in FIG. 11, the above-described stop angle 0 and the like may be determined without considering the mirror viewing area 105, but considering only the viewing area which is the overlapping area of the direct viewing area 104 and the merging destination lane 400.

In addition, when the merging travel control is executed by the autonomous driving in the travelling lane 300, in a case where the distance L is sufficiently long and there is sufficient time for switching the driving mode from the autonomous driving to the manual driving, the travel control unit 14 gives prior notice to the driver through the HMI 8 to switch the driving mode to the manual driving and causes the host vehicle 100 to travel slowly by the autonomous driving. Thus, it is possible to avoid the collision with a following vehicle due to the stopping. When the following vehicle approaches, the travel control unit 14 maintains the speed. As described above, in a case where the switching of the driving mode from the autonomous driving to the manual driving or the stop control is executed, but the preceding vehicle travelling in the travelling lane 300 suddenly stops, the host vehicle 100 may be caused to stop immediately by the autonomous driving.

Furthermore, in the merging determination, in a case where it is determined by the determination unit 15 that the merging travel control cannot be executed, or in a case where it is determined by the determination unit 15 that the merging travel control cannot be executed and it is determined by the determination unit 15 that there is no time to switch the driving mode from the autonomous driving to the manual driving, the stop control unit 16 may execute the stop control to control the travelling of the host vehicle 100 in such a manner that the host vehicle 100 stops only toward the boundary line 304 between the travelling lane 300 and the merging destination lane 400 at the merging place 303 based on the host vehicle information and the map information without setting the stop angle θ. In this way, it is possible to reduce the calculation loading to calculate the stop angle θ with reference to the direct viewing area 104 and the mirror viewing area 105. In this case also, similar to the embodiment described above, the host vehicle 100 may be stopped in such a manner that the direction of the steered wheel 106 of the host vehicle 100 becomes parallel to the extending direction 305 of the travelling lane 300 at the merging place 303, or the host vehicle 100 may be stopped in such a manner that the direction of the steered wheel 106 of the host vehicle 100 does not become parallel to the extending direction 305 of the travelling lane 300 at the merging place 303.

What is claimed is:

1. An autonomous driving device configured to perform a merging travel control of a host vehicle that travels by autonomous travelling toward a merging place between a travelling lane in which the host vehicle travels and a merging destination lane to which the travelling lane merges, in such a manner that the host vehicle merges into the merging destination lane by the autonomous driving, the device comprising:
an another vehicle information acquisition unit configured to acquire another vehicle information relating to another vehicle travelling in the merging destination lane toward the merging place;
a host vehicle information acquisition unit configured to acquire host vehicle information relating to the host vehicle;
a map database configured to store map information;
a determination unit configured to determine whether or not the merging travel control can be executed based on the another vehicle information, the host vehicle information, and the map information; and
a stop control unit configured to control the travelling of the host vehicle in such a manner that the host vehicle stops in the travelling lane toward the boundary line between the travelling lane and the merging destination lane at the merging place, in a case where it is determined by the determination unit that the merging travel control cannot be executed.

2. The autonomous driving device according to claim 1,
wherein the stop control unit is configured to cause the host vehicle to stop in such a manner that an angle between a center axis extending in a longitudinal direction of the host vehicle and a direction of the merging destination lane at the merging place becomes the preset angle based on the host vehicle information and the map information.

3. The autonomous driving device according to claim 1,
wherein, in a case where it is determined by the determination unit that the merging travel control cannot be executed, the stop control unit is configured to cause the host vehicle to stop in such a manner that the direction of the steered wheel of the host vehicle becomes parallel to the extending direction of the travelling lane at the merging place.

4. The autonomous driving device according to claim 2,
wherein, in a case where it is determined by the determination unit that the merging travel control cannot be executed, the stop control unit is configured to cause the host vehicle to stop in such a manner that the direction of the steered wheel of the host vehicle becomes parallel to the extending direction of the travelling lane at the merging place.
